(19) United States
(12) Patent Application Publication
(10) Pub. No.: US 2006/0225244 A1
(43) Pub. Date: Oct. 12, 2006

(54) Curtain rail slider

(76) Inventors: Sebastien Melinette, Seclin Cedex (FR); Savine Lepretre, Seclin Cedex (FR)

Correspondence Address: EVEREST INTELLECTUAL PROPERTY LAW GROUP, P. O. BOX 708, NORTHBROOK, IL, 60065, US

(21) Appl. No.: 11/386,906

(22) Filed: Mar. 22, 2006

(30) Foreign Application Priority Data
Apr. 12, 2005 (FR) 0503604

(51) Int. Cl. E05D 15/06

(52) U.S. Cl. 16/93 R

(57) ABSTRACT

A curtain rail slider for a rail comprising a longitudinal channel with an open slot (7), comprising a hanger member (8) for a curtain or the like, a retention body (9) provided on the hanger member (8) and being capable of sliding in the channel (3) and at least one elastic arm (12), which slider is characterized in that the retention body is of generally parallelepiped shape with side faces (10) defining between themselves a thickness that is less than the width of the open slot (7) of the rail and a sliding face (11) perpendicular to the side faces, the elastic arm (12) being inclined, extending in a direction perpendicular to the said side faces of the retention body, and having an unattached end (12a) situated beyond the sliding face (11) of the retention body and a width less than the width of the open slot of the rail.

### CROSS-REFERENCE TO RELATED APPLICATIONS

The entire disclosure of French patent application number 0503604 filed on Apr. 12, 2005 is incorporated herein by reference in its entirety.

### BACKGROUND OF THE INVENTION

1. Field of the Invention

The present invention relates to a curtain rail slider for a rail comprising a longitudinal channel with an open slot, in which a plurality of sliders can be mounted. A slider of this kind usually comprises a hanger member for a curtain or for a piece of fabric or other similar material.

2. Description of the Related Art

The prior art already includes curtain rail sliders for such channel rails which cannot however be mounted except from the end of the rail or through an opening provided especially for this purpose, at a particular point in the rail. Clearly, this type of slider is not very practical because of the difficulty of assembly.

Again, the prior art includes sliders for channel rails of this type, which can be assembled anywhere along the channel, generally by means of the presence of one or more elastically deformable elements. The sliders may be fitted for example by inserting obliquely a part of the slider designed to be fitted inside the channel and to slide inside the channel.

For instance, German utility model 85 27 230.2 discloses a curtain rail slider in which an elastically deformable portion can be engaged inside the channel of the rail by presenting the slider obliquely to the open slot of the channel.

With such a slider, excessive traction can result in deformation and can pull it out of the channel of the rail.

Again, French patent application 2 631 533 discloses a curtain rail slider which is also fitted obliquely by means of an elastic lip which can bend during fitting, and then return elastically to act as a sliding surface for the slider inside the channel of the rail.

The structure of such a slider is complex because of the existence of the elastic lips, which are connected to guide flanges which are themselves elastic. Also, the sliding of the slider on relatively thin elastic lips makes the whole structure weak.

Swiss patent 559 027 discloses a curtain slider having two rigid gliding flanges that glide along the inside surfaces of the channel. To insert it, the slider has to be turned through 90°, with elastic arms pressing on the outside of the rail. When the slider has been fitted, the elastic arms remain deformed and there is a fair amount of friction between them and the outside surface of the rail when the slider is slid along. Such friction not only wears the sliders out but also makes it difficult to open or close the curtains.

It is an object of the present invention to solve the difficulties that occur with conventional curtain rail sliders.

More precisely, the subject of the invention is a curtain rail slider for a rail with a longitudinal channel, that is easier to fit at any point along the rail, is strong, slides with little friction, and cannot come out accidentally when the curtain attached to the slider is pulled, even when it is pulled at an angle.

### SUMMARY

In one embodiment, a curtain rail slider for a rail comprises a longitudinal channel with an open slot, comprising a hanger member for a curtain or the like, a retention retention body provided on the hanger member and being capable of sliding in the channel and at least one elastic arm. The retention body is less in thickness than the width of the open slot and greater in length than the width of the open slot, and includes side faces and a sliding face perpendicular to the side faces. The elastic arm is inclined, and extends in a direction perpendicular to the side faces of the retention body, and has an unattached end situated beyond the sliding face of the retention body. The elastic arm has a width less than the width of the open slot of the rail.

To fit such a slider into the channel of the rail, all that is necessary is to push the retention body into the channel, allowing the elastic arm to deform elastically against the outer edge of the slot of the rail. The retention body itself is able to fit inside the channel because its thickness is slightly less than the width of the open slot of the rail. Once the sliding face is level with the inside faces of the slot, the slider is turned 90° on itself.

During this rotation, the elastic arm remains deformed against the outer edge of the slot. As soon as the rotation is completed, and the lateral faces of the retention body are perpendicular to the slot axis, the elastic arm engages in the slot, its elasticity enabling it to resume its original, undeformed shape. Its engagement is made possible by the fact that the elastic arm is narrower than the slot. The user is also alerted to this engagement by the sound of a slight click, which corresponds to the return of the elastic arm to its original, undeformed position.

In a preferred embodiment, the slider comprises two symmetrical elastic arms extending from each side of the said side faces of the retention body.

The slider may comprise a junction portion situated between the retention body and the hanger member.

The slider may also comprise a sliding plate between the retention body and the hanger member.

Each elastic arm may be attached to the junction portion or to the sliding plate.

In one embodiment, the sliding face of the retention body has at least one rounded portion so that the retention body is easier to rotate when the slider is being fitted to the rail.

In another embodiment, a curtain rail assembly comprises a rail including a longitudinal channel and an open slot communicating therewith, a slider reciprocally movable along the rail and including a hunger member for hanging a curtain or the like thereon, a retention body provided on the hanger member and being reciprocally movable within the channel and a pair of elastic arms provided on the retention body. The slider 1 is rotatable between a first position in which the retention body is parallel to the open slot and is capable to be fit through the open slot into the channel and a second position in which the retention body is perpendicular to the open slot and is prevented from coming out of the open slot. When the slider assumes the first position, the elastic arm comes into contact with the outer face of the channel under elastic deformation and when the slider assumes the second position, the elastic arm comes into fitting engagement with the open slot.

A clearer understanding of the invention will be gained from studying the detailed description of one embodiment taken as an example that is in no way restricted, illustrated in the accompanying drawings in which:

### DESCRIPTION OF THE DRAWINGS

FIG. 1 is a schematic view of one embodiment of a slider according to the invention, also showing in cross section the rail into which the slider is to be fitted;

FIG. 2 is a view similar to FIG. 1, showing the slider at an intermediate stage of fitting with partial deformation of the elastic arms;

FIG. 3 is a view similar to FIGS. 1 and 2, showing the slider fitted into the channel of the rail after rotation through 90°; and

FIG. 4 is a perspective view showing the slider inside the rail as in FIG. 3.

### DETAILED DESCRIPTION

As illustrated in the figures, a curtain rail assembly A is comprised of a curtain rail 2 and a slider 1 intended to be fitted into the curtain rail 2 so as to be reciprocally movable on the curtain rail 2. The rail 2 comprises a longitudinal channel 3 of approximately rectangular section. The channel is bounded by a wall 4, generally the top wall 4 of the rail 2, fixed for example to the ceiling of a room, two side walls 5, and a bottom wall 6 having an open slot 7 defining two bottom wall portions 6a, 6b for the slider 1 to slide on when fitted.

The slider 1 comprises a hanger member 8 which in the example illustrated is a closed ring, but which could of course be a hook or any other appropriate member on which a curtain or similar item could be hung.

The slider 1 also includes a retention body 9, which is of generally parallelepiped shape. The retention body 9 includes an upper face 15 which is to face the upper wall 4 of the channel 3, two mutually parallel opposite side faces 10, two opposite end faces 16 and a lower face opposite to the upper face 15. A junction portion 14 is provided protuberantly in the middle of the lower face. The two remaining parts of the lower face on the opposite sides of the junction portion 14 constitute sliding faces 11. The thickness of the retention body 9 as measured between the two opposite side faces 10 is slightly less than the width of the open slot 7. The thickness of the retention body 9 has only to be narrower than the width of the slot 7 to allow it to be inserted without difficulty into the channel 3, through the said slot 7. The length of the retention body 9 as measured between the two opposite end faces 16 is greater than the width of the open slot 7.

The sliding face 11 can, in the second position shown in FIG. 3, come into sliding contact with the inside faces of the bottom wall portions 6a and 6b so that the slider 1 can slide along the inside of the channel 3. The sliding face 11 is perpendicular to the side faces 10 of the retention body 9.

The slider 1 is rotatable on its axis between a first position in which the retention body 9 is parallel to the open slot 7 and is capable to be fit through the open slot 7 into the channel 3 and a second position in which the retention body 9 is perpendicular to the open slot 7 and is prevented from coming the open slot 7

It is also possible for the sliding face 11 to be slightly rounded or to have rounded edges in the vicinity of its ends or the corners where the sliding faces 11 join the relevant end faces 16, as shown in the attached figures, so that the retention body 9 can be rotated easily during fitting, as will be explained below.

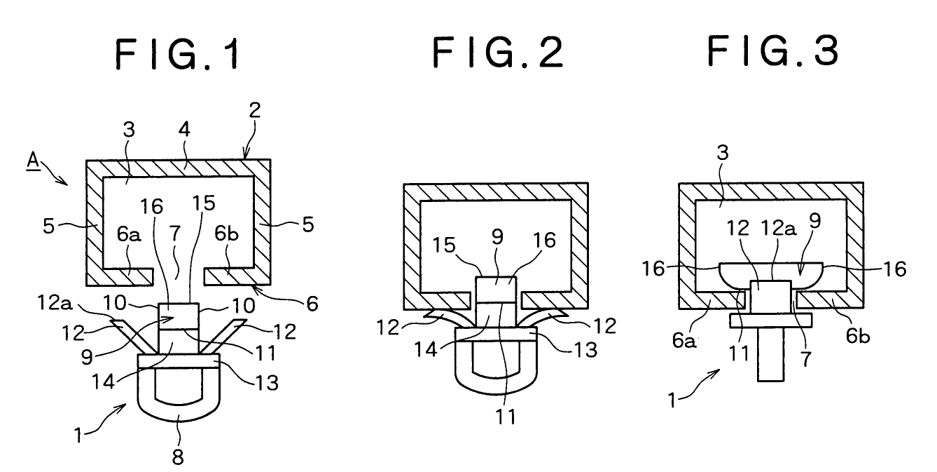

The retention body 9 also includes, in the example shown, two elastic arms 12 arranged symmetrically on each side of the retention body 9. The two elastic arms 12 are inclined at an angle of about 45° in the example shown. They are joined at one end to the slider 1 and are attached to a sliding plate 13. The junction portion 14 is disposed between the sliding plates 13 and the retention body 9. The unattached end of each of the elastic arms 12, which diverges on either side of the retention body 9 from the end attached to the sliding plate 13, is situated beyond the sliding face 11 of the retention body 9 when the said elastic arms 12 are not under load. This can be seen particularly in FIG. 1, where the ends of the elastic arms 12 can be seen to be above the level of the sliding face 11.

These inclined elastic arms 12 extend from either side of the retention body 9, in a direction which is perpendicular to the side faces 10 of the retention body 9.

The fitting of the slider 1 will now be described.

In FIG. 1, the slider 1 is not yet fitted into the rail 2. When the slider assumes the first position, the slider 1 is pushed through the open slot 7 into the channel 3. In this movement the retention body 9 is able to pass through the slot 7 because its thickness is less than the width of the said slot 7. The unattached ends 12a of the two elastic arms 12 first contact the outer face of the two bottom wall portions 6a, 6b. At this point, no rotation of the slider 1 is possible because the parallelepiped shape of the retention body 9 resists such rotation, the length in section of the said retention body being greater than the width of the slot 7, as can be seen, for example, in FIG. 3.

Further engagement of the slider 1 into the channel 3 causes bending and deformation of the two elastic arms 12, as shown in FIG. 2. In the position shown in FIG. 2, the deformation of the elastic arms 12 is not yet complete and the sliding face 11 of the retention body 9 has not yet risen above the inside face of the wall portions 6a, 6b. In this position it is therefore still impossible to turn the slider 1 because the parallelepiped shape of the retention retention body 9 resists such rotation.

Still further engagement of the slider 1 results in the sliding face 11 rising above the inside face of the wall portions 6a and 6b, owing to the dimensions given to the junction portion 14. Once this height is arrived at, the slider 1 can simply be turned through 90° to thus assume the second position shown in FIG. 3. During this rotation, the two elastic arms 12, still deformed and in contact with the outer face of the two wall portions 6a, 6b, slide with friction over the said walls until they are lined up with the longitudinal slot 7. The two elastic arms 12, whose width is less than the width of the slot 7, as shown in FIG. 3, then immediately elastically resume their initial shape. This is indicated to the user by the sound of a slight click. The width of the elastic arms 12 is preferably very slightly less than the width of the slot 7, as shown in FIG. 3.

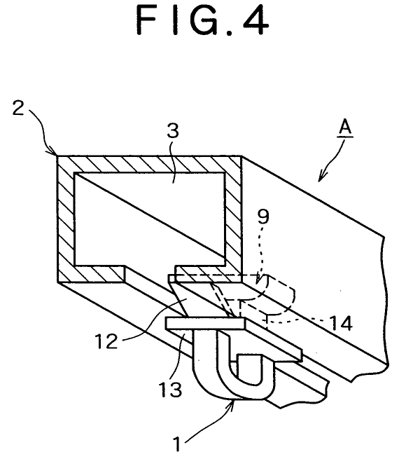

Because of the arrangement of the two elastic arms 12, and because their unattached ends 12a are situated beyond the sliding face 11, the said ends 12a are inside the channel 3. In this way the elastic arms 12 resist any new rotation of the slider 1 as their edges come into contact with the edges of the slot 7 or the respective edges of the opposed bottom wall portions 6a, 6b of the rail 2, as shown in FIGS. 3 and 4.

The slider 1 is thus fitted into the rail 2. Specifically, in the second position, the slider 1 is able to slide along inside the channel 3 with the sliding face 11 in sliding contact with the inside face of the wall portions 6a and 6b of the channel 3 to thus prevent the retention body 9 from coming out of the channel 3. The sliding plate 13 is in sliding contact with the outer face of the bottom wall portions 6a and 6b along the edges of the longitudinal slot 7.

Fitting of the slider 1 is possible at any point inside the rail 2. The resistance of the slider 1 to being pulled out is greatly improved by the fact that it is the entirety of the retention retention body 9 which is exerting this resistance, as opposed to thin elastic arms, as was the case in the earlier devices.

### CONCLUSION, RAMIFICATIONS, AND SCOPE

Once the elastic arm is housed in the slot, the slider can no longer be turned because the elastic arm, part of which is in the slot, resists such rotation. The slider is therefore fitted securely in the channel and cannot be detached from the rail.

The slider can easily be fitted in the channel of the rail, and, once fitted, cannot be detached, for example by pulling vertically or at an angle on the curtain attached to the slider. Naturally, the rail may include an area where the slot is locally enlarged to allow the sliders to be removed.

Removal of the slider 1 is securely prevented by the fact that rotation is prevented by the elastic arms 12.

Although the example illustrated shows a slider with two symmetrical elastic arms, it will be understood that a single elastic arm could also be envisaged.

The slider is advantageously made of a moulded synthetic material, such as polyester, all of its parts being moulded. The thickness of the constituent material of the elastic arms will be selected in such a way as to give the said elastic arms the required elasticity.

Although the description above contains many specificities, these should not be construed as limiting the scope of the invention but as merely providing illustrations of some of the presently preferred embodiments of this invention.

Thus the scope of the invention should be determined by the appended claims and their legal equivalents, rather than by the examples given.

What is claimed is:

1. A curtain rail slider for a rail comprising a longitudinal channel with an open slot, comprising a hanger member for a curtain or the like, a retention retention body provided on the hanger member and being capable of sliding in the channel and at least one elastic arm, which slider is characterised in that the retention body is less in thickness than the width of the open slot and greater in length than the width of the open slot, and includes side faces and a sliding face perpendicular to the side faces, the elastic arm being inclined, extending in a direction perpendicular to the side faces of the retention body, and having an unattached end situated beyond the sliding face of the retention body and a width less than the width of the open slot of the rail.

2. Curtain rail slider according to claim 1, comprising two symmetrical elastic arms extending from each side of the said side faces of the retention body.

3. Curtain rail slider according to claim 1, comprising a junction portion situated between the retention body and the hanger member.

4. Curtain rail slider according to claim 1, comprising a sliding plate between the retention body and the hanger member.

5. Curtain rail slider according to claim 3, in which each elastic arm is attached to the junction portion.

6. Curtain rail slider according to claim 4, in which each elastic arm is attached to the sliding plate.

7. Curtain rail slider according to one of the preceding claims, in which the sliding face of the retention body has rounded edges in the vicinity of its ends.

8. A curtain rail assembly comprising a curtain rail including a longitudinal channel and an open slot communicating therewith, and a slider reciprocally movable along the rail and including a hunger member for hanging a curtain or the like thereon, a retention body provided on the hanger member and being reciprocally movable within the channel and a pair of elastic arms provided on the retention body; the slider being rotatable between a first position in which the retention body is parallel to the open slot and is capable to be fit through the open slot into the channel and a second position in which the retention body is perpendicular to the open slot and is prevented from coming out of the open slot; when the slider assumes the first position, the elastic arm coming into contact with the outer face of the channel under elastic deformation and when the slider assumes the second position, the elastic arm coming into fitting engagement with the open slot.

9. A curtain rail assembly according to claim 1, the retention body including a sliding face which comes into and out of sliding contact with the inside faces of the channel when the slider assumes the second position and the first position, respectively.

10. A curtain rail assembly according to claim 8, the elastic arms being disposed between the edges of the open slot, when the slider assumes the second position.
